(19) United States
(12) Patent Application Publication
(10) Pub. No.: US 2013/0119992 A1
(43) Pub. Date: May 16, 2013

(54) Automatic Locator Antenna Tuning System

(71) Applicant: The Charles Machine Works, Inc., Perry, OK (US)

(72) Inventor: Brian K. Bailey, Stillwater, OK (US)

(73) Assignee: The Charles Machine Works, Inc., Perry, OK (US)

(21) Appl. No.: 13/675,217

(22) Filed: Nov. 13, 2012

Related U.S. Application Data
(60) Provisional application No. 61/559,205, filed on Nov. 14, 2011.

(51) Int. Cl. G01V 3/10

(52) U.S. Cl. CPC G01V 3/101
USPC 324/326

(57) ABSTRACT

A tuning system for a receiver of magnetic field signals. The system utilizes a stable magnetic source of known frequency, and detects a strength of the magnetic field at an antenna assembly. The strength of the magnetic field is recorded by a processor, and a control signal is adjusted to change the center frequency of the antenna assembly. Further, two or more antennas in an antenna assembly may be balanced through the same method. A variable reactance means in communication with the processor is utilized to change the center frequency of individual antennas and the antenna assembly as a whole to tune the antenna and optimize a signal to noise ratio at the receiver.

### CROSS REFERENCE TO RELATED APPLICATION

This application claims the benefit of provisional patent application Ser. No. 61/559,205 filed on Nov. 14, 2011, the entire contents of which are incorporated herein by reference.

### FIELD OF THE INVENTION

The present invention relates generally to the field of receiver antennas used in line locating, specifically the tuning of receiver antennas.

### SUMMARY OF THE INVENTION

The present invention is directed to an automatically tunable locator apparatus for locating an object. The apparatus comprises a means for generating a stable magnetic field, an antenna, a variable reactance means, and a processor. The antenna detects a parameter of the magnetic field at a frequency range. The variable reactance means changes the center frequency of the frequency range in response to a control signal. The processor receives the strength of the magnetic field and adjusts the control signal to maximize the strength of the magnetic field.

In another embodiment, the invention is directed to a method for tuning an antenna assembly. The method comprises providing a stable magnetic field at a desired frequency, detecting a first strength of the magnetic field at the antenna assembly, recording the first strength, adjusting a variable reactance means to manipulate a center frequency of the antenna assembly, detecting a second strength of the magnetic field of the antenna assembly, and determining which of the two magnetic field strengths is greatest.

In another embodiment, the invention is directed to a receiver tuning system. The system comprises an antenna assembly, a measurement system, an antenna tuning circuit, a variable reactance means, and a magnetic field source. The measurement system is operatively connected to the antenna assembly and comprises a processor. The antenna tuning circuit changes a center frequency of the antenna assembly. The variable reactance means is operably connected to the antenna and the processor such that the processor can vary the center frequency of the antenna tuning circuit. The magnetic field source is positioned such that the antenna assembly is located in the magnetic field.

### BACKGROUND OF THE INVENTION

A basic cable locating system consists of a transmitter and a receiver, or locator. The transmitter couples an AC current of a predetermined frequency onto the target cable. The locator responds to the magnetic field generated by the current on the cable and gives feedback to the operator allowing him to locate the cable.

The locator typically detects the magnetic field using a solenoid style magnetic loop antenna which is part of an antenna circuit. The antenna circuit includes at least an antenna and a tuning capacitor, and usually a resistor, arranged to create a parallel resonant circuit. This circuit has a resonant frequency that is a function of the antenna inductance and capacitance and a bandwidth which is a function of the inductance, capacitance, and resistance. The quality factor, Q, of the circuit is calculated by dividing the resonant frequency by the bandwidth and is a measure of how sharply tuned the circuit is. Note that in some designs the tuning capacitor is a parasitic capacitance created by the close proximity and large mutual area of the antenna windings.

Prior to this invention, receiver tuning has been done manually. The typical variable reactance elements used have been variable capacitors or inductors that are adjustable via mechanical means. This means that an operator must physically access the tuning element and turn a variable capacitor or inductor by hand to make an adjustment. Not only is this a cumbersome operation, it has the following complications:
The receiver housing must allow access to the adjustments to tune a completed receiver
Mechanical adjustments are inherently less reliable than solid state devices
Mechanically adjusted devices are subject to change with vibration and time

The magnitude of the voltage across the receiver antenna can be reasonably represented by

V∝ω·Q·N·A·μₑ·H

Where V is the voltage across the receiver antenna, ω is the angular frequency in radians, Q is the quality factor of the circuit, N is the number of turns of wire on the antenna, A is the cross sectional area of the antenna, μₑ is the effective permeability of the core, and H is the intensity of the magnetic field. Since ω is equal to 2*pi*frequency and the receiver is operating at a single frequency at any given time, we remove ω. We then remove H and assume a constant magnetic field intensity. This leaves

V∝Q·N·A·μₑ

To increase the performance of a receiver antenna circuit, one of these four variables must be manipulated. Increasing the turns count, N, will increase signal proportional to the number of turns, but will increase noise by the same amount. Similar performance gains are attainable by increasing antenna cross-sectional area and effective permeability. Increasing Q increases signal proportional to the Q increase, but unlike the other variables increases the signal to noise ratio by reducing receiver bandwidth and attenuating out of band frequencies.

In a conventional multi-frequency receiver it is standard practice to have a low Q or reasonably flat tune. This gives the receiver the wide bandwidth it needs to function over a large range of frequencies. It trades performance at each individual frequency for cost effectiveness and simplicity.

In a high performance cable locator it is desirable to use a high Q tuned antenna to increase signal output at the frequency of interest and better reject nearby frequencies. Such an antenna must be tuned such that the peak frequency response is reasonably close to the frequency being detected to gain these benefits.

### BRIEF DESCRIPTION OF THE DRAWINGS

FIG. 1 is a diagrammatic representation of an antenna tuning system in accordance with the present invention.

FIG. 2 is a line drawing of an automatic antenna tuning system.

FIG. 3 is a top view of a left-right antenna configuration.

FIG. 4 is a line drawing of left-right automatic antenna tuning system.

FIG. 5 is a flow chart depicting a method of using the present invention.

### DETAILED DESCRIPTION OF THE DRAWINGS

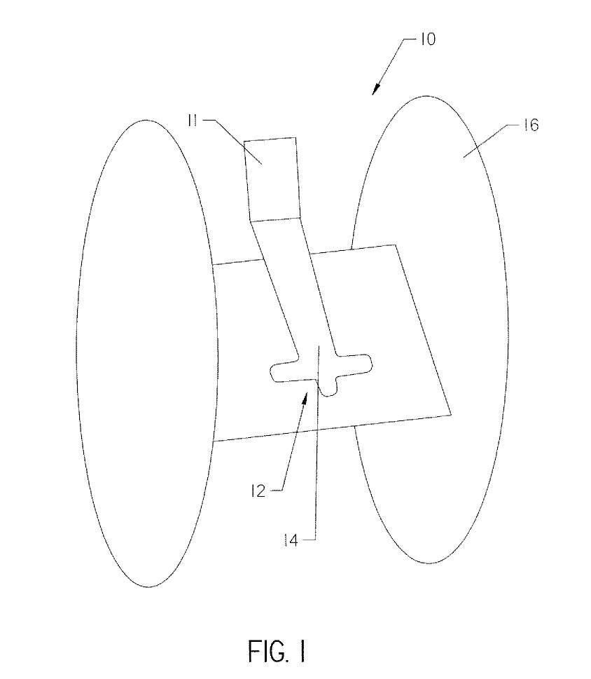

With reference now to the figures in general, and FIG. 1 in particular, shown therein is an antenna tuning system 10 for use with a locator 11. The antenna tuning system 10 comprises an antenna, or antenna assembly 12, an antenna tuning circuit 14, and a means for generating a stable magnetic field 16.

The antenna assembly 12 may comprise a single coil, a ferrite rod, a tri-axial antenna assembly or a combination of the above. The antenna assembly 12, once tuned with the tuning system 10 of the present invention, is used with a locator 11 to detect a location of an underground object, such as a cable or utility line (not shown).

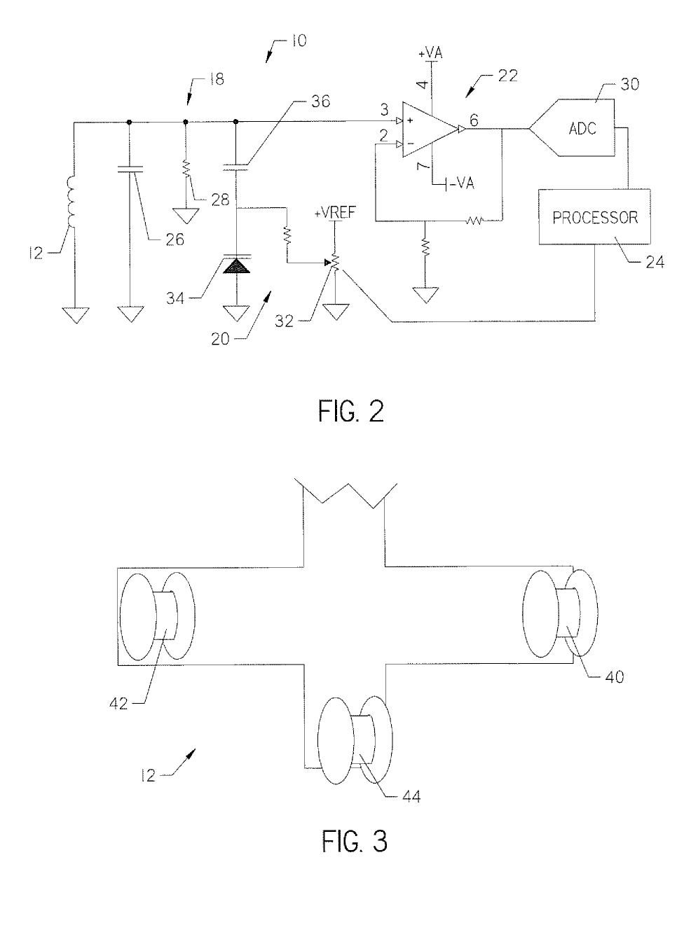

With reference now to FIG. 2, the antenna tuning system 10 comprises a parallel resonance circuit 18, a variable reactance means 20, an amplifier 22 and a processor 24. The parallel resonance circuit 18 comprises a first capacitor 26 and a resistor 28. The output of the parallel resonance circuit 18 indicates a signal strength detected by the antenna 12. This output is then amplified by the amplifier 22 and delivered to a signal measurement system comprising the processor 24. As shown, the processor 24 comprises an analog-digital converter 30 (ADC) to process the amplified signal and convert it to digital format.

The processor 24 is capable of adjusting the variable reactance means 20. The variable reactance means 20 comprises a potentiometer 32 and a varactor diode 34. The varactor diode 34 may include a capacitor 36. A control signal, such as a voltage across the potentiometer 32 is adjusted by the processor 24 to increase or decrease the capacitance of the varactor diode 34. As the capacitance is increased, the variable reactance means 20 adjusts the target frequency detected by the antenna 12. The processor 24 iteratively adjusts the potentiometer 32 to automatically identify the highest measured signal and record the corresponding potentiometer 32 setting in its memory.

Tuning the antenna 12 is accomplished by adjusting the inductive and/or capacitive portion of the antenna tuning circuit 14 so that, at the target frequency of interest, the capacitive reactance and the inductive reactances of the parallel resonance circuit 18 are of equal magnitude and opposite polarity. This maximizes signal magnitude at the center frequency, or frequency of interest, amplifying it by a factor of Q. Tuning also improves performance by reducing the bandwidth of the receiver which reduces the magnitudes of nearby interfering frequencies with respect to the magnitude of the target frequency, improving the signal to noise ratio.

Therefore, it may be desired that before the tuning process begins, the antenna 12 may be placed in a magnetic field of the proper frequency. Therefore, the antenna is placed within the means for generating a stable magnetic field 16 (FIG. 1). This means 16 may comprise a Helmholtz coil or other structure that produces a substantially uniform magnetic field around the antenna assembly 12. This makes the magnetic field strength less sensitive to the antenna assembly 12 position.

The magnetic field source 16 may comprise a Helmholz coil due to the uniformity of the magnetic field near the center of such a source. The coil will need to be sized appropriately for the particular antenna assembly 12. The magnetic field source 16 is used as a frequency reference in the tuning methods described herein. The magnetic field source 16 may also be used as an amplitude, phase, or directional reference.

With reference now to FIG. 3, an antenna assembly 12 with a left-right antenna configuration comprises a horizontally oriented right antenna 40, left antenna 42, and bottom antenna 44 to determine the lateral direction and approximate distance to the cable or utility line to be located. The bottom antenna 44 is located near the center of the locator 11. An optional top antenna, not shown, can be used to calculate ratiometric depths. The left 42 and right 40 antennas may be separated by several inches. The left 42 and right 40 antennas may be connected in series with opposite polarity.

With reference to FIGS. 1 and 3, when the locator 11 with this antenna assembly 12 is positioned directly over the center of a cable carrying a current at or very near the target frequency, the magnetic field intensity at the left 42 and right 40 antennas will be equal. This causes reasonably equal signals to be induced in both the left and right antennas. Since the antennas 40, 42 are connected in series with opposite phase, the reasonably equal signals will subtract and result in an output signal near zero. When the locator 11 is moved to either side of the cable (not shown), different strength magnetic fields at the left and right antennas produce different signals which when subtracted will have a significant magnitude. This magnitude relative to the bottom antenna 44 signal magnitude is used to estimate a lateral offset of the locator 11 from the line (not shown). The phase of this signal relative to the bottom antenna 44 signal is used to determine the lateral direction to the line. This information may be displayed at the locator 11 to an operator.

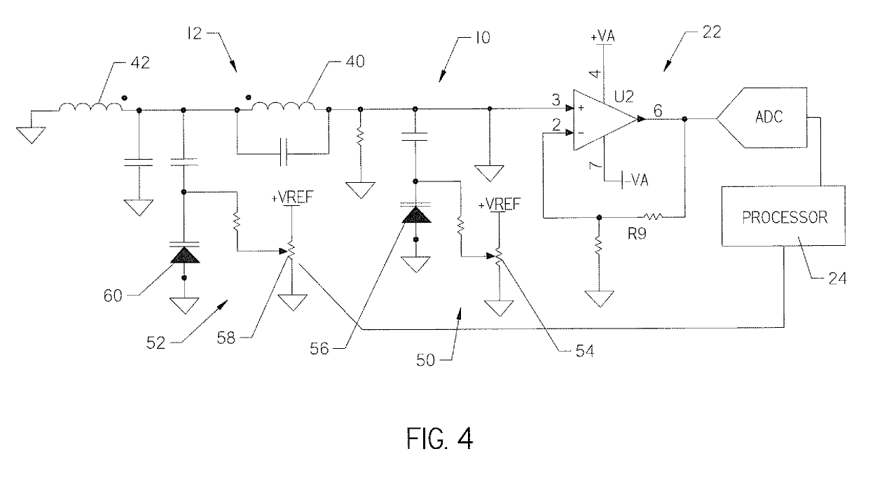

Referring now to FIG. 4, a tuning system 10 for left-right antenna assembly 12 is shown in more detail. In this embodiment, the antenna tuning system 10 comprises the antenna assembly 12 comprising the left antenna 42 and the right antenna 40. The system 10 further comprises a tuning variable reactance means 50, a balancing variable reactance means 52, the amplifier 22 and the processor 24. The amplifier receives a signal from the antenna assembly 12. The processor 24 adjusts the tuning variable reactance means 50 to maximize the signal strength. The tuning variable reactance means 50 comprises a potentiometer 54 and a varactor diode 56. The capacitance of the varactor diode 56 is adjusted by manipulating the potentiometer 54 while the antenna assembly 12 is in a stable magnetic field at the target frequency. The processor 24 may iteratively determine the value of the control signal on the potentiometer 54 that corresponds to the highest signal magnitude and stores it in memory for later use.

The left-right balance can be adjusted through use of the balancing variable reactance means 52. The balancing variable reactance means 52 comprises a balancing potentiometer 58 and a balancing varactor diode 60. The processor 24 may adjust the control signal, such as a voltage, on the potentiometer 58 to adjust the capacitance on the balancing diode 60 to achieve a target phase relationship between the left antenna 42 and right antenna 40. The processor may use an iterative process as disclosed above to determine the proper phase relationship.

While voltage is specifically mentioned as an exemplary control signal, one skilled in the art can envision that alternative control signals can adjust the tuning variable reactance means 50 and the balancing variable reactance means 52. These alternative control signals may comprise a current, a mechanical adjustment, or other signals.

One skilled in the art will appreciate that the antenna assembly 12 of the locator 11 is located within a housing (not shown) that may cause some interference with the signal. Use of the various variable reactance means 50, 52 allows the antenna tuning system 10 to compensate for misalignment of the antenna assembly 12 relative to the housing.

Automating the tuning process has several advantages over manual tuning. It is more accurate, more repeatable, faster, and reduces human error. Using the processor 24 to perform this task is far more repeatable and less error prone. Automatic tuning also does not require a person to be in close proximity to the sensitive antenna assemblies 12 during tuning which, particularly at higher frequencies, causes distortion of the magnetic field and may result in inaccuracy. The left-right balance is particularly sensitive to this distortion. Automatic tuning can also now be performed indoors; conditions can be tightly controlled which results in more predictable performance in the field.

Automatic tuning could be used with any variable reactance means 20, 50, 52 used as the tuning element. The methods may vary slightly to accommodate different variable reactance devices. The variable reactance tuning element(s) may be solid state for increased reliability and repeatability, resistance to vibration. Automatic tuning could also be used to tune an antenna assembly 12 to a point other than the maximum or minimum signal strength. Variable reactance could be adjusted to match a target signal level (matching two antennas) or phase.

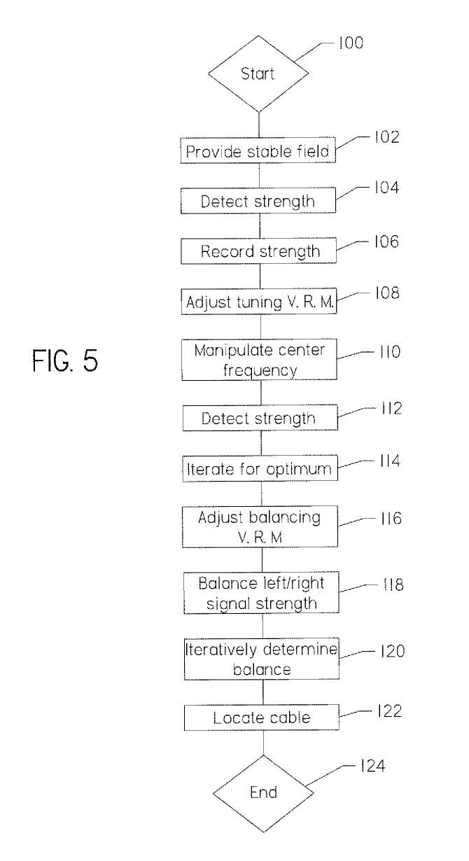

With reference now to FIG. 5, in operation, the antenna tuning system 10 is operated using a method beginning at 100. A stable magnetic field is provided at 102 by a means for producing a magnetic field 16 such as a Helmholtz coil. The antenna assembly 12 is placed within the stable magnetic field and a first strength is detected at 104. The strength is recorded at 106 by the processor 24. The processor 24 adjusts the tuning variable reactance means 50 at 108, which in turn adjusts the varactor diode 56 to manipulate the center frequency of the antenna assembly 12 at 110. The signal strength is again detected at 112 and an optimal diode adjustment point is iteratively determined by the processor 24 at 114. Additionally, if left 42 and right 40 antennas are used in the antenna assembly 12, the balancing variable reactance means 52 is adjusted at 116 by the processor 24. This adjustment uses the balancing varactor diode 60 to balance the strength of the field detected at the first antenna and the second antenna at 118. An optimal adjustment of the balancing varactor diode is determined iteratively by the processor 24 at 120. Once tuning is complete, the tuned locator 11 may be used to locate an underground cable at 122. The method ends at 124.

Alternatively, an operator could place the locator 11 in a fixture and use an interface to remotely tune the antenna assembly 12. This would place the operator far enough from the antennas to minimize magnetic field distortion while making adjustments. Remote tuning retains many of the advantages over manually tuning the antenna assembly 12, particularly if paired with an appropriate magnetic field source 16.

Although the present invention has been described with respect to the preferred embodiment, various changes and modifications may be suggested to one skilled in the art, and it is intended that the present invention encompass such changes and modifications as fall within the scope of this disclosure.

What is claimed is:

1. An automatically tunable locator apparatus for locating an object, the apparatus comprising:
a means for generating a stable magnetic field;
an antenna to detect a parameter of the magnetic field at a frequency range;
a variable reactance means for changing a center frequency of the antenna in response to a control signal; and
a processor for receiving the strength of the magnetic field and adjusting the control signal to maximize the strength of the magnetic field.

2. The apparatus of claim 1 wherein the means for generating a stable magnetic field comprises a Helmholtz coil.

3. The apparatus of claim 1 wherein the variable reactance means comprises a varactor diode.

4. The apparatus of claim 1 wherein the variable reactance means comprises a capacitor.

5. The apparatus of claim 1 further comprising a second antenna.

6. The apparatus of claim 4 further comprising a balancing diode, wherein the strength of the field detected at the antenna and the second antenna are balanced by the balancing diode.

7. The apparatus of claim 1 further comprising a housing wherein the antenna is located inside the housing.

8. The apparatus of claim 7 wherein the variable reactance means compensates for misalignment of the antenna relative to the housing.

9. The apparatus of claim 1 wherein the control signal comprises a voltage.

10. A method for tuning an antenna assembly comprising:
providing a stable magnetic field at a desired frequency;
detecting a first strength of the magnetic field at the antenna assembly;
recording the first strength;
adjusting a variable reactance means to manipulate a center frequency of the antenna assembly;
detecting a second strength of the magnetic field at the antenna assembly; and
determining which of the two magnetic field strengths is greatest.

11. The method of claim 10 wherein providing a stable magnetic field comprises using a Helmholtz coil.

12. The method of claim 10 wherein target frequency is determined by adjusting the variable reactance means adjustment point to maximize the strength of the detected magnetic field.

13. The method of claim 10 wherein the antenna assembly comprises a first antenna and a second antenna.

14. The method of claim 13 further comprising providing a balancing variable reactance means to balance the strength of the field detected at the first antenna and the second antenna.

15. The method of claim 13 wherein the variable reactance means is adjusted to achieve a target phase relationship between the first antenna and the second antenna.

16. The method of claim 10 further comprising iteratively repeating the steps of detecting a strength and adjusting the variable reactance means to achieve the maximized detected magnetic field strength.

17. The method of claim 10 further comprising iteratively repeating the steps of detecting a strength and adjusting the variable reactance means to achieve a minimized detected magnetic field strength.

18. The method of claim 17 wherein the iterative repetition is performed by a processor.

19. A receiver tuning system comprising
an antenna assembly;
a measurement system operatively connected to the antenna assembly comprising a processor;
an antenna tuning circuit to change a center frequency of the antenna assembly;
a variable reactance means operably connected to the antenna and the processor such that the processor can vary the center frequency of the antenna tuning circuit; and
a magnetic field source positioned such that the antenna assembly is located in the magnetic field.

20. The system of claim 19 wherein the antenna assembly comprises a first antenna and a second antenna wherein the first antenna and the second antenna are subjected to substantially equal magnetic field strength along a common antenna axis.

21. The system of claim 20 further comprising a balancing variable reactance means wherein the balancing variable reactance means balances the strength of the field detected at the first antenna and the second antenna.

22. The system of claim 19 where all antennas in the receiver are subjected to substantially equal magnetic field strength and direction

23. The system of claim 19 where the magnetic field is used as a reference to tune one or more antennas.

24. The system of claim 19 where the magnetic field is used as a reference to substantially match the amplitude of two or more antennas.

25. The system of claim 19 where the magnetic field is used as a reference to adjust the phase relationship of two or more antennas.

26. The system of claim 19 wherein the variable reactance means comprises a varactor diode.
